(19) United States
(12) Patent Application Publication
(10) Pub. No.: US 2002/0135873 A1
(43) Pub. Date: Sep. 26, 2002

(54) Three-dimensional images and method of manufacture thereof

(76) Inventor: Joseph D. Franko SR., Ham Lake, MN (US)

Correspondence Address: ROBERT A PAJAK, PATENT SERVICES, 14234 NAPLES STREET NE, HAM LAKE, MN, 55304

(21) Appl. No.: 09/814,323

(22) Filed: Mar. 21, 2001

(51) Int. Cl. G02B 27/22

(52) U.S. Cl. 359/463; 359/462

(57) ABSTRACT

An in-line three-dimensional image construction includes an optically clear film having a top surface and a bottom surface. A reverse interlaced image is provided on at least a portion of the bottom surface of the optically clear film. A plurality of lenticules are provided on the top surface of the optically clear film opposite the reverse interlaced image on the bottom surface of the optically clear film, corresponding to the interlaced image. An illusion of a 3D image corresponding to the interlaced image results from viewing the interlaced image through the plurality of lenticules.

A method of manufacturing the in-line three-dimensional image construction includes providing an optically clear film having a top surface and a bottom surface, with the film being defined by a lengthwise machine direction reference axis, and by a transverse reference axis that is substantially perpendicular to the lengthwise machine direction reference axis. A reverse interlaced image is printed on the bottom surface of the film, with the image being oriented substantially parallel to the machine direction reference axis, or, alternatively, substantially parallel to the transverse reference axis. A plurality of lenticules are created on the top surface of the film, opposite the reverse interlaced image on the bottom surface, and corresponding to the interlaced image. The lenticules are, respective to the interlaced image, oriented substantially parallel to the machine direction reference axis or, alternatively, substantially parallel to the transverse reference axis.

### FIELD OF THE INVENTION

The present invention relates generally to images having a three-dimensional (3D) illusion. The invention relates specifically to materials which provide illusions of 3D images, and to an in-line converting and printing process for manufacture thereof.

### BACKGROUND OF THE INVENTION

In the printing arts, and in particular in the commercial printed label art for labeling and decorating consumer products, there exists a continual demand for labels and decorations which appeal to consumers; indeed, the commercial success of a given product often relies heavily upon consumer appeal for product packaging and specifically for product decoration and labeling.

Accordingly, manufacturers and retailers have sought marketing strategies for consumer products which exploit the consumer appeal of product labels and decorations (hereinafter, collectively, “labels”). Over the years, labels have evolved from simple printed text descriptions of products, to “eye-catching” multi-color graphics incorporating intricate designs along with product descriptions. Generally, each new label is designed with novelty and brand recognition in mind; label designs tend to be innovative and intriguing to the consumer, in addition to having aesthetic appeal and being identifiable with a particular brand.

It is often desired to impart a special visual effect to a label, such as that of three-dimensionality or of motion. Labels having these three-dimensional (“3D”) or motion characteristics are usually considered to be consumer-interactive, for, it is hoped, increased consumer awareness and resulting increased sales of the product so labeled.

In general, 3D and motion visual effects have been costly and difficult to achieve; meanwhile, product manufacturers have demanded that labels be produced for their products as inexpensively as possible, to protect profit margins.

Typically, a pre-formed lenticular lens material is utilized for production of labels having the 3D or motion effect. Lenticular lens material, as known in the art, utilizes rows of simple and commonly dome-shaped lenses or “lenticules”, in combination with a lineform or interlaced image, to create a 3D or motion illusion. The lens material is, for the most part, optically clear, and has a flat side and a “lenticulated” side comprising the lenticules. The lineform or interlaced image comprises image segments oriented into contiguous juxtaposed rows. These image segments are typically created on a base material, such as paper, film, or the like. The image segments are specifically designed to correspond to the lenticules of the lens material, and vice-versa. The flat side of the lens material is secured against the segmented image at an orientation where the lenticules are in alignment with the image segments. When the image is then viewed through the lenticulated side of the lens material, a visual 3D or motion illusion results. Discussions of fabrication and use of lenticular lens material, and of lineform or interlaced images, are contained within U.S. Pat. Nos. 5,488,451; 5,617,178; 5,847,808; and 5,896,230, each issued to Goggins.

Examples of production of 3D or motion visual effect labels are found in U.S. Pat. No. 5,967,032 entitled “PRINTING PROCESS USING A THIN SHEET LENTICULAR LENS MATERIAL” issued to Bravenec, et al; and in U.S. Pat. No. 5,266,995 entitled “METHOD FOR FORMING A GRAPHIC IMAGE WEB” issued to Quadracci, et al.

The Quadracci patent discloses the coupling or “marrying” of pre-formed and separately supplied lenticular material with the printed lineform or interlaced image. The Bravenec patent discloses the printing of the image directly onto the flat side of the lenticular material.

It is generally accepted and well-known in the label making arts that in-line printing and converting processes may offer the most cost-effective label production. Exemplary in-line methods are disclosed in U.S. Pat. Nos. 5,560,799 and 5,753,344, each entitled “IN-LINE PRINTING PRODUCTION OF THREE DIMENSIONAL IMAGE PRODUCTS INCORPORATING LENTICULAR TRANSPARENT MATERIAL” and issued to Jacobsen. The Jacobsen patents utilize a pre-lenticularized film in an in-line process.

The aforementioned patented processes are predicated upon a supply of a pre-lenticularized, or lenticular, film. The supply of such lenticular film is usually provided for the in-line processes in roll- or sheet-fed form. Substantial difficulties may be encountered with reliance upon a supply of lenticular film to an in-line process. Chief among these difficulties, relative to label production, is that of lenticular orientation relative to a web direction (a direction in which a relatively long sheet or web of material is travelling through an in-line printing and converting press). As is well-known in the label making art, the web direction of an in-line process largely determines the orientation of labels, relative to the web direction, being produced by the process. In an in-line process using a supply of a pre-lenticularized lens material, consideration must be given to the web direction because, as aforesaid, the lens material must be correctly aligned with the image. Such existing processes may be unable to provide lenticular images in an orientation that is perpendicular to the web direction, as may be desired.

Also, the orientation and overall registration of the image with the lens material may be incorrect when utilizing pre-lenticularized material, with the 3D or motion illusion therefore not achievable.

Further, the use of pre-lenticularized material usually results in an inability to provide portions of a label web having no lenticularization. For many applications, it may be desirable to provide lenticularized and non-lenticularized areas of the web such that resulting produced labels may each be a composite of a lenticular image having a 3D effect for “shelf appeal”, and a non-lenticular or “standard” image that clearly provides, for example, specific product information.

Thus, there exists a need for a material which provides an illusion of a 3D image that is inexpensive and simple to fabricate, and for an in-line converting and printing process therefor that does not rely upon on a supply of pre-lenticularized material.

### SUMMARY OF THE INVENTION

An object of the present invention is to provide a material which provides an illusion of a 3D image, and to an in-line converting and printing process for manufacture thereof.

Another object of the present invention is to provide a material which provides an illusion of a 3D image that is inexpensive and simple to fabricate.

Yet another object of the present invention is to provide an in-line converting and printing process that does not rely upon on a supply of pre-lenticularized material.

A further object of the present invention is for an in-line process that provides lenticular images in an orientation that is perpendicular to the web direction, and in which overall registration of the image with the lens material is correct for achieving a 3D or motion illusion.

A still further object of the present invention is for an in-line process that provides portions of a label web having no lenticularization.

In accordance with the present invention, a material which provides an illusion of a three-dimensional (3D) image is constructed in an in-line converting and printing process. The construction includes an optically clear film having a top surface and a bottom surface, with an interlaced image provided on at least a portion of the bottom surface of the film. Lenticules are embossed or are otherwise formed on the top surface of the film, corresponding to the interlaced image.

### BRIEF DESCRIPTION OF THE DRAWINGS

FIG. 1 is a perspective illustration of a preferred embodiment of an in-line three-dimensional image construction, in accordance with the present invention.

FIGS. 2a and 2b are perspective illustrations of opposite sides of a component of the image construction shown in FIG. 1.

FIG. 3 is a perspective illustration of a process of the in-line three-dimensional image construction, being applied to the component shown in FIG. 2b.

FIG. 3a is a magnified side view of FIG. 3, taken along reference line L.

FIG. 4 is a perspective illustration of another embodiment of the in-line three-dimensional image construction of the present invention.

FIG. 5 is a schematic diagram of an in-line manufacturing process of the present invention.

### DETAILED DESCRIPTION OF THE INVENTION

In the following exposition, the term “optically clear film” is used to describe any film or material that is suitable for use in the printing arts and has a substantially transparent quality. Material compositions of such commercially available films may include, for example, polypropylene, polyester, polyethylene, polyvinylchloride, and polystyrene. All such compositions are considered to be polymeric film materials and are synonymous therewith.

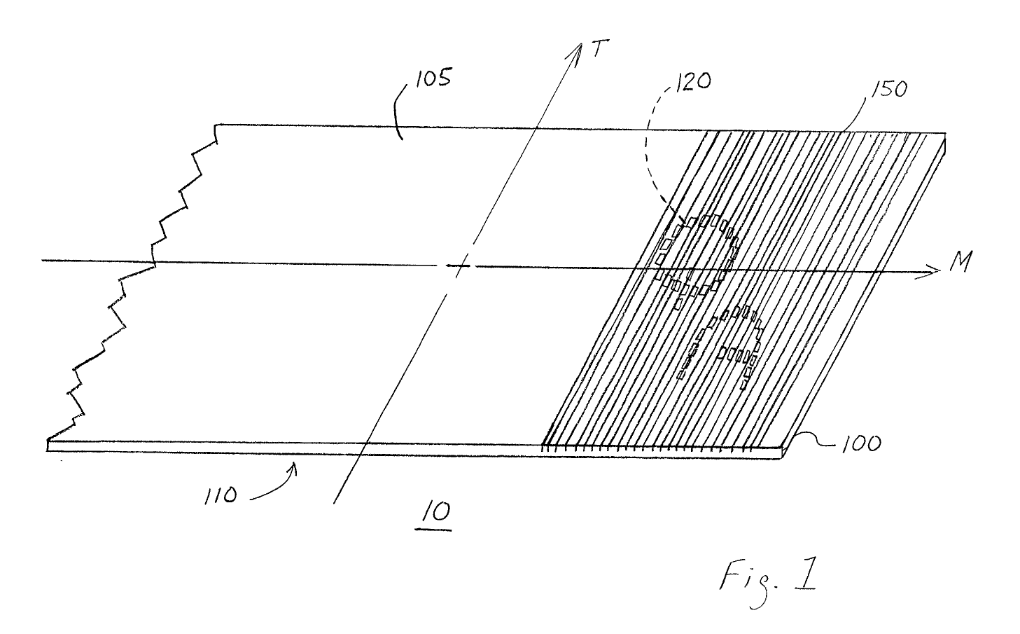

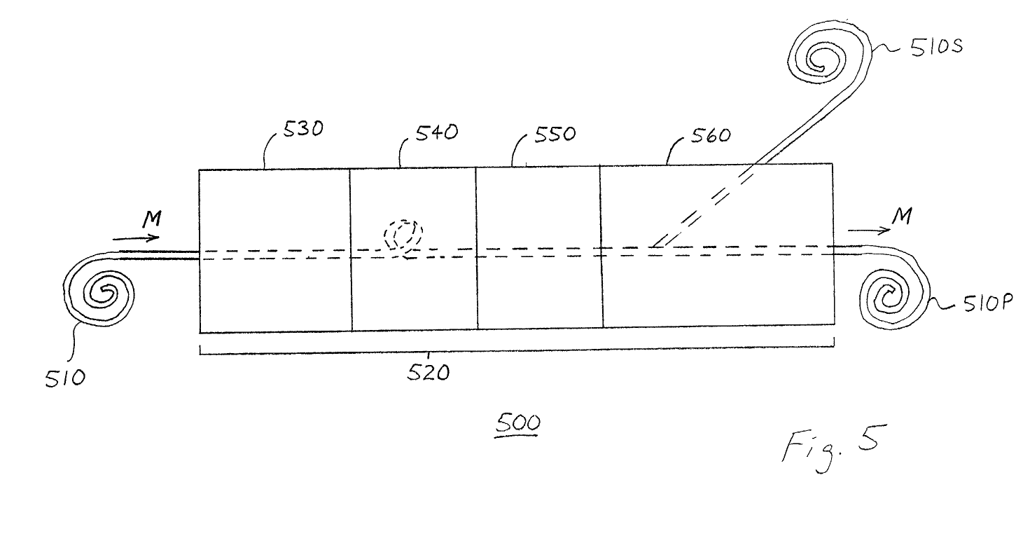

Referring to FIG. 1, thereshown is a perspective illustration of an in-line three-dimensional image construction 10. Image construction 10 includes an optically clear film 100, a lineform or interlaced image 120, and lenticules 150. Preferably, for the instant in-line process, optically clear film 100 is provided in roll or web form for introduction to an in-line printing and converting press, as will be further described with reference to FIG. 5.

Optically clear film 100 has a top surface 105 and a bottom surface 110. Dimensions of film 100 are defined by a lengthwise machine direction reference axis M and a transverse reference axis T. Transverse reference axis T is substantially perpendicular to axis W. As will be further described, lineform or interlaced image 120 is provided on bottom surface 110 of film 100. Lenticules 150 are provided on top surface 105 of film 100, in a process that will also be further described. It is to be appreciated that optical characteristics of optically clear film 100 allow image 120 to be viewed through top surface 105 including lenticules 150. Specifically, when image 120 is viewed through lenticules 150, an illusion of three-dimensionality or of motion may be observed in image 120.

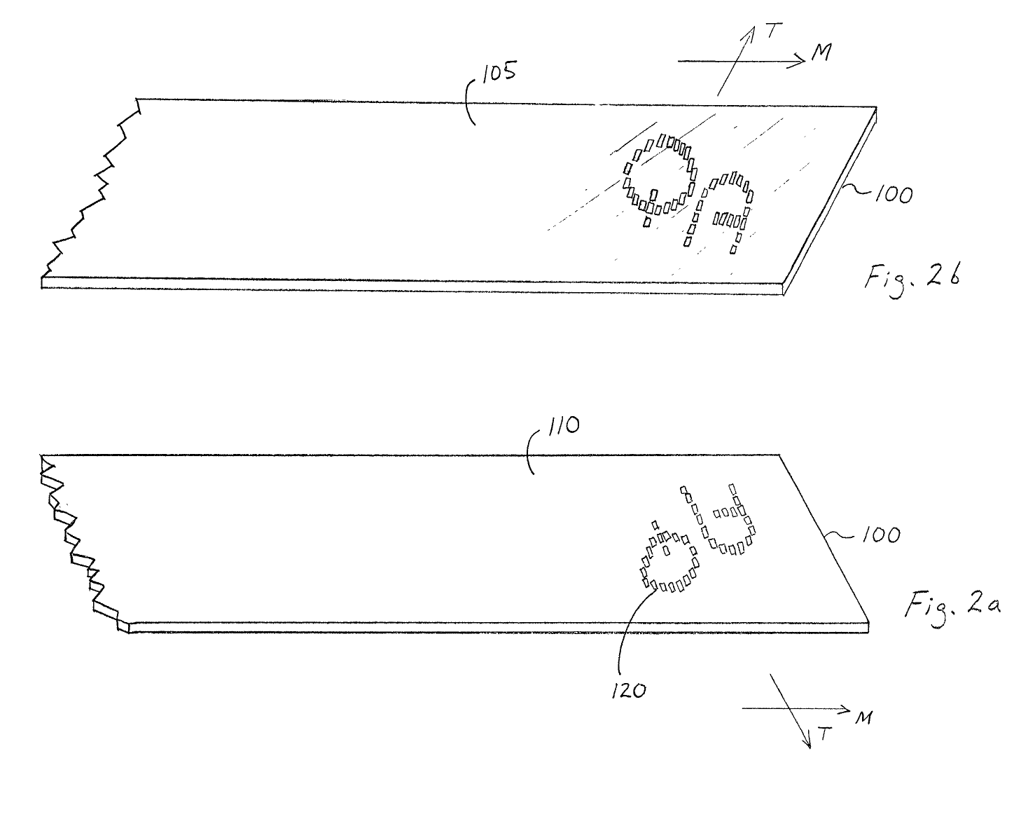

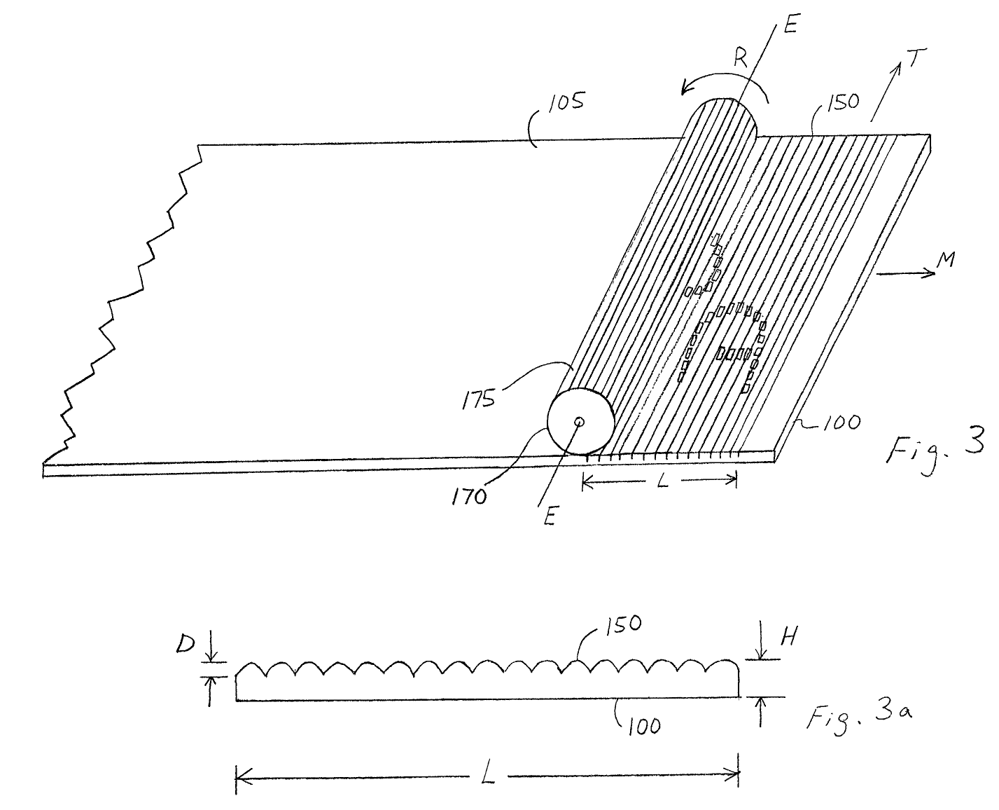

Turning, now, to FIGS. 2a and 2b, bottom surface 110 and top surface 105 of film 100 are depicted. In FIG. 2a, interlaced image 120 has been provided on bottom surface 110, in reverse fashion. It is to be understood in the figures that image 120 as depicted is intended to be only a diagrammatic representation of an actual interlaced image. In FIG. 2b, reverse interlaced image 120 provided on bottom surface 110 is visible through top surface 105 and through film 100 itself. In FIG. 3, film 100 is being transported in a direction of axis M under embosser 170, for formation of lenticules 150 on top surface 105 of film 100. As is well known in the in-line printing and converting arts, an embossing technique typically utilizes a roller, plate, or some other source of pressure to impart a desired shape or texture to a web material. Herein, embosser 170 embodies a roller having a selected number of embossing channels 175. As embosser 170 forcibly rolls in a direction R about its cylindrical axis E on top surface 105 of film 100, lenticules 150 are formed in film 100 in the well-known manner of such embossing devices. Depth and width dimensions of channels 175 of embosser 170 are carefully chosen such that lenticules 150 are formed into uniform desired dimensions. Although schematically depicted as a cylindrical device, embosser 170 may comprise any suitable flatbed or rotary embossing die technique, as known in the art. Furthermore, it is to be understood that embosser 170 may operate in a direction of lengthwise machine direction reference axis M (as shown in FIG. 3, with axis E parallel to transverse reference axis T) or in a direction of transverse reference axis T (not illustrated—with axis E parallel to lengthwise machine direction reference axis W). Therefore, the present invention is capable of forming lenticules in an orientation that is either parallel, or perpendicular, to machine direction reference axis W, as may be desired for making a particular label web.

FIG. 3a is a magnified side view of lenticules 150 shown in FIG. 3, taken along reference line L. Therein, an overall height H and depth D of lenticules 150 is illustrated. Typically, H is about 0.007″ to 0.012″, while D is about 1/3 of L1.

As aforesaid, the number of lenticules 150 are chosen to correspond directly to the dimensions of interlaced image 120. Commonly, about 75 to 200 lenticules per inch of web are employed, again depending upon the dimensions of interlaced image 120.

Although not illustrated in FIGS. 1-3a, an opaque coating may be applied to bottom surface 110 of film 100, over image 120, to enhance “viewability” of image 120 through lenticules 150.

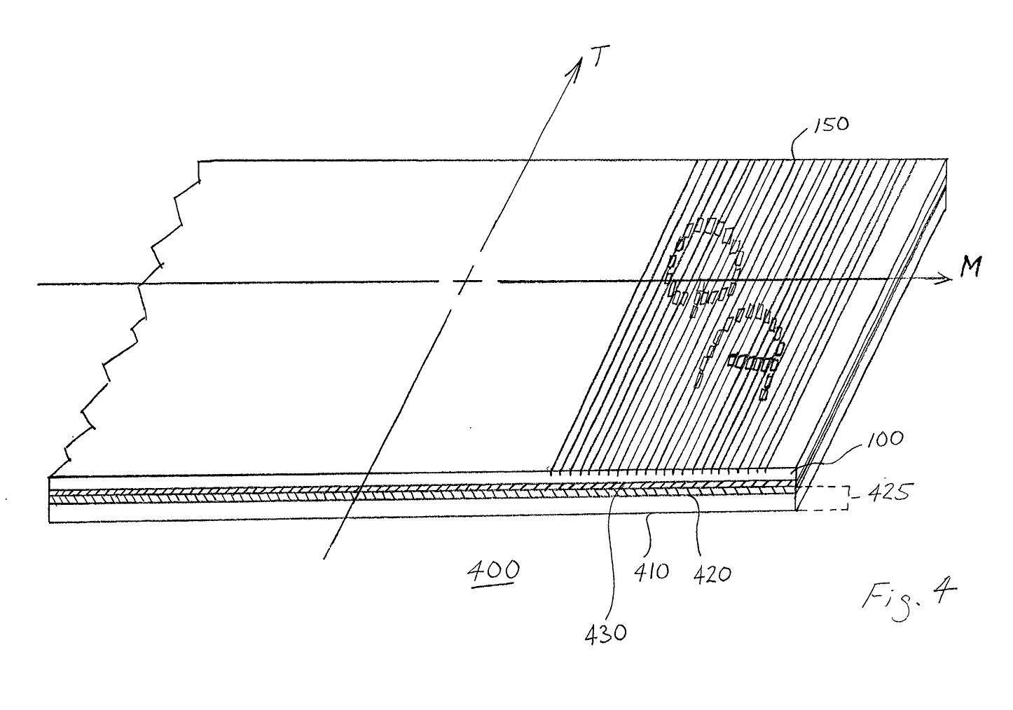

FIG. 4 illustrates an alternative embodiment of the 3D image construction of the present invention.

Therein, a base web is coupled with film 100 to form an in-line three-dimensional image construction 400. As an exemplary alternative embodiment, the base web is a pressure-sensitive (p-s) adhesive laminate base web. It is to be understood, however, that any suitable in-line base web (whether a p-s adhesive laminate, an unsupported film, or an unsupported paper base, for example) may be coupled with film 100 as desired.

In FIG. 4, typical components of an exemplary p-s adhesive laminate base web are depicted. Therein, the p-s adhesive laminate base web includes a liner 410 having a release coating 420 provided thereon. Release coating 420 is commonly impregnated into liner 410 to form an overall release liner 425 having a unitary construction. A full-coat p-s face adhesive 430 is provided on film 100. As known in the art, adhesive 430 may be patterned as desired. In turn, film 100 via adhesive 430 is provided in removable adhesive contact with release liner 425. As known to those skilled in the art, release coating 420 functions to allow removal or “peel off” of release liner 425 from adhesive 430 of film 100, for exposure of face adhesive 430 as desired when film 100 is to be adhesively applied to, for example, a container to be labeled. It is to be understood that, for example, a heat-activated adhesive laminate base web, or even a simple glue laminate base web, could be substituted for the exemplary p-s adhesive laminate base web for a particular labeling need as is known in the art.

Release liner 425 is commercially available in roll form for in-line printing and converting (as will be described in manufacture of an in-line three-dimensional image construction 10) from, for example, Rhinelander Paper Company of Rhinelander, Wis.

FIG. 5 depicts an exemplary in-line web press manufacturing scheme 500 for mass production of Image construction 10.

Therein, an unprocessed film web 510 (or a p-s adhesive laminate combined with an unprocessed film web 510) is shown as being supplied in a conventional roll form to a multi-unit press 520, in a direction of lengthwise machine direction reference axis M (of FIGS. 1-4). Like the aforedescribed combination of liner 410 and release coating 420, film web 510 is readily commercially available and has properties that may be identical to those of the aforedescribed optically clear film 100.

Multi-unit press 520 typically includes a printing station 530, a web turning station 540, a lenticularizing station 550, and a converting station 560, as will be further described.

With additional reference to FIGS. 2a-b, film web 510 (having a top surface and a bottom surface like those shown in FIGS. 2a-b) is supplied to press 520 at printing station 530. Printing station 530 performs an operation of printing or otherwise applying a desired interlaced image on the bottom surface of web 510. It is to be understood that press 520 is selectively capable of providing a variable number of print stations (not illustrated) for application and drying of pigmented inks, coatings, and adhesives applied to film web 510. As understood by those of ordinary skill in the printing arts, the exemplary multi-unit press 520 may be any suitable narrow- or wide-web press such as a flexographic, letterpress, gravure, screen, or offset press. Such presses are commercially available from, for example, Comco International of Milford, Ohio, or Mark Andy Inc. of St. Louis, Mo.

After the interlaced image is provided on the bottom surface of web 510, web 510 is turned over by web turning station 540 such that the top and bottom surfaces of web 510 exchange positions in a top and bottom sense within press 520. This turning of web 510 may be provided by, for example, a turn-bar technique as is known in the art.

Film web 510 is then passed downstream to lenticularizing station 550 for formation of lenticules thereon (as aforedescribed with reference to FIGS. 3-3a).

Lenticularized film web 510 is next passed to converting station 560, where die cutting or other perforation techniques may be performed on web 510 for creation of individual labels comprising three-dimensional image constructions 10, as is well-known in the art.

Converting station 560 also performs an operation of removing waste or scrap 510S from web 510 having been die cut to form individual labels as aforedescribed. Re-winding of waste 510S may then be accomplished by any number of well-known re-winding methods, for ease of disposal thereof.

Finally, web 510 containing the individual labels comprising three-dimensional image constructions 10 may be re-wound into a supply roll as a finished product 510P, again by way of any number of well-known methods, for ease of handling thereof. Alternatively, of course, web 510 could be processed into a stack of sheets (not illustrated) containing a series of individual labels.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

For example, in the exemplary in-line web press manufacturing scheme 500 of FIG. 5, and as mentioned above with reference to FIG. 3, lenticularizing station 550 may be capable of forming lenticules 150 in an orientation that is either parallel, or perpendicular, to machine direction reference axis M, as may be desired for making a particular label web.

Further, lenticularizing station 550 of FIG. 5 may employ, as an alternative to embosser 170 of FIG. 3, any suitable screen printing and/or extruding technique. Such a screen printing and/or extruding technique may utilize, for example, flowable and/or viscous clear inks, resins, or varnishes, for selected formation of lenticules 150. In such a technique, the “curing” or drying time of the ink, resin, or varnish is closely monitored for proper “doming” and creation, accordingly, of lenticules 150.

Additionally, in-line three-dimensional image construction 10 and its manufacturing scheme 500 may employ any suitable full or partial embossing (via modifications to embosser 170 and lenticularizing station 550) and full or partial screen printing, for “spot” lenticular coverage as may be desired in, for example, production of a particular label.

It is to be understood that any suitable alternatives may be employed to provide the in-line three-dimensional image construction of the present invention, along with its manufacturing scheme.

Lastly, the choice, of course, of compositions, sizes, and strengths of various aforementioned components of in-line three-dimensional image construction 10 are all a matter of design choice depending upon intended uses of the present invention.

Accordingly, these and other various changes or modifications in form and detail of the present invention may also be made therein, again without departing from the true spirit and scope of the invention as defined by the appended claims.

What is claimed is:

1. An in-line three-dimensional image construction, comprising:
an optically clear film having a top surface and a bottom surface;
a reverse interlaced image provided on at least a portion of said bottom surface of said optically clear film; and
a plurality of lenticules provided on said top surface of said optically clear film opposite said reverse interlaced image on said bottom surface, corresponding to said interlaced image,
wherein an illusion of a 3D image corresponding to said interlaced image results from viewing said interlaced image through said plurality of lenticules of said optically clear film.

2. A method of manufacture of an in-line three-dimensional image construction, comprising the steps of:
(a) providing an optically clear film having a top surface and a bottom surface, wherein said optically clear film is defined by a lengthwise machine direction reference axis, and by a transverse reference axis being substantially perpendicular to said lengthwise machine direction reference axis;
(b) printing a reverse interlaced image on said bottom surface of said optically clear film, with said reverse interlaced image being oriented substantially parallel to said lengthwise machine direction reference axis; and
(c) creating a plurality of lenticules on said top surface of said optically clear film, opposite said reverse interlaced image on said bottom surface, corresponding to said interlaced image with said lenticules being oriented substantially parallel to said lengthwise machine direction reference axis.

3. The method of claim 2, wherein said reverse interlaced image and said lenticules are oriented substantially parallel to said transverse reference axis.

4. The method of claim 2, wherein said step of creating a plurality of lenticules is selected from a group consisting of an embossing technique, a screen printing technique, and an extruding technique.

5. The method of claim 2, wherein said bottom surface of said optically clear film is, at least in part, opaquely coated.

6. The method of claim 5, wherein said at least in part opaquely coated bottom surface is coated, at least in part, with an adhesive.

7. A method of manufacture of an in-line three-dimensional image construction, comprising the steps of:
(a) providing a base web having,
(i) a lengthwise machine direction reference axis, and a transverse reference axis being substantially perpendicular to said lengthwise machine direction reference axis,
(ii) a bottom surface, and
(iii) a printable top surface;
(b) printing at least one interlaced image on said printable top surface of said base web, with said interlaced image being oriented substantially parallel to said lengthwise machine direction reference axis;
(c) laminating said printable top surface of said base web with an optically clear laminating web, said optically clear laminating web having dimensions being substantially equivalent to said lengthwise machine direction reference axis and to said transverse reference axis of said base web; and
(d) creating a plurality of lenticules on said top surface of said optically clear laminating web, opposite said interlaced image on said printable top surface, corresponding to said interlaced image with said lenticules being oriented substantially parallel to said lengthwise machine direction reference axis.

8. The method of claim 7, wherein said interlaced image and said lenticules are oriented substantially parallel to said transverse reference axis.

9. The method of claim 7, wherein said base web is selected from a group consisting of paper, polypropylene, polyester, co-polyester, polyethylene, polyvinylchloride, polystyrene, polycarbonate, and acrylic.

10. The method of claim 7, wherein said bottom surface of said base web is coated, at least in part, with an adhesive coating.

11. The method of claim 7, wherein a liner having a release coating is provided in contact with said adhesive coating.

12. The method of claim 7, further comprising the step of cutting through said laminating web and said base web about said at least one interlaced image, for formation of at least one label being separable from a remaining portion of said laminating web and said base web.

13. A method of manufacture of an in-line three-dimensional image construction, comprising the steps of:
(a) providing a base web having,
(i) a lengthwise machine direction reference axis, and a transverse reference axis being substantially perpendicular to said lengthwise machine direction reference axis,
(ii) a bottom surface, and
(iii) a printable top surface;
(b) printing at least one interlaced image on said printable top surface of said base web, with said interlaced image being oriented substantially parallel to said lengthwise machine direction reference axis;
(c) screen printing a selected portion of said printable top surface of said base web with an optically clear screen print; and
(d) creating a plurality of lenticules on a selected portion of said optically clear screen print, opposite said interlaced image on said printable top surface, corresponding to said interlaced image with said lenticules being oriented substantially parallel to said lengthwise machine direction reference axis.

14. The method of claim 13, wherein said interlaced image and said lenticules are oriented substantially parallel to said transverse reference axis.
